(19) United States
(12) Patent Application Publication
(10) Pub. No.: US 2010/0071015 A1
(43) Pub. Date: Mar. 18, 2010

(54) APPARATUS FOR VIDEO AND AUDIO REPRODUCTION

(75) Inventors: Kazumi Tomioka, Yokohama-shi (JP); Hiroaki Komaki, Tachikawa-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/496,418

(22) Filed: Jul. 1, 2009

(30) Foreign Application Priority Data
Sep. 18, 2008 (JP) 2008-239976

(51) Int. Cl. H04N 7/173

(52) U.S. Cl. 725/110; 348/563

(57) ABSTRACT

According to an embodiment, displays a message displaying area is able to utilized as a messenger function and a schedule displaying area is able to utilized as a scheduler function in a display device of a television function part based on control information and setting information analyzed by an advanced function control module in a remote control part in accordance with a clock time managed by a clock module when a commercial power is connected with an image processing module, a display, a audio processing module, a audio reproducer, and a graphic processing module through a power supply.

### CROSS-REFERENCE TO RELATED APPLICATIONS

This application is based upon and claims the benefit of priority from Japanese Patent Application No. 2008-239976, filed Sep. 18, 2008, the entire contents of which are incorporated herein by reference.

### BACKGROUND

1. Field

The present invention relates to a television receiver and a method that reproduce content provided from a television broadcast or a network and can be utilized as a scheduler or a messenger at home.

2. Description of the Related Art

Generally, when developing a scheduler or a messenger function that utilizes a display unit of a television receiver, a network must be used.

Japanese Patent Application Publication (KOKAI) No. 2007-228107 discloses an online communication system that bi-directionally transmits or receives pictures, audio, and data between a plurality of terminals through a communication network. It is to be noted that paragraph [0007] in this document clearly specifies utilization of a server.

The online communication system explained in the Publication requests connection of a television receiver with respect to a network typified by, e.g., the Internet.

### BRIEF DESCRIPTION OF THE SEVERAL VIEWS OF THE DRAWING

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing an example of a television receiver and a method of supplying control information and setting information to the television receiver from the outside according to an embodiment of the invention;

FIG. 2 is an exemplary diagram showing an example of constituent elements included in the television receiver shown in FIG. 1 according to an embodiment of the invention;

FIG. 3 is an exemplary diagram showing an example of examples of a messenger screen and a scheduler screen displayed in a display of the television receiver shown in FIG. 2 according to an embodiment of the invention; and

FIG. 4 is an exemplary diagram showing an example of a multi-screen display associated with a request of displaying different programs (channels) at the same time instant in the television receiver shown in FIG. 2 according to another embodiment of the invention.

### DETAILED DESCRIPTION

Various embodiments according to the invention will be described hereinafter with reference to the accompanying drawings. In general, according to one embodiment of the invention, a video and audio reproduction apparatus characterized by comprising: a display configured to display an image; a communication control module configured to receive instruction information including moving picture or still picture data and audio data; a receiving module configured to receive a program or content; an information processing module configured to analyze the instruction information received by the communication control module; a data holding module configured to hold at least one of acquisition reservation information of a program or content as an acquisition reservation target in the receiving module, a message included in an analysis result obtained by the information processing module, and setting information included in the analysis result obtained by the information processing module in accordance with the analysis result obtained by the information processing module; a display processing module configured to display in the display a screen associated with at least one of the acquisition reservation information, the message, and configured to set information held by the data holding module; a clock module configured to manage clock time information; and a control module configured to control at least one of the receiving module and the display in accordance with at least one of the acquisition reservation information, the message, and the setting information displayed in the display by the display processing module based on the clock time information from the clock module.

Embodiments of this invention will be described in detail with reference to the drawings. The various modules of the systems described herein can be implemented as software applications, hardware and/or software modules, or components on one or more computers, such as servers. While the various modules are illustrated separately, they may share some or all of the same underlying logic or code.

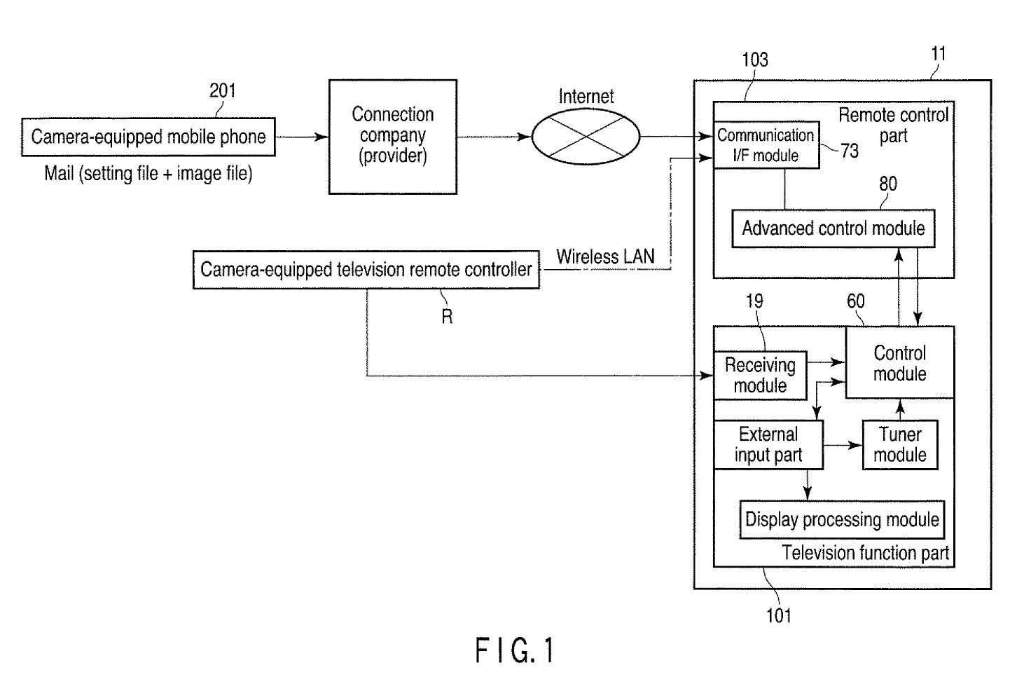

FIG. 1 shows an example of a television receiver (video and audio reproduction apparatus) to which an embodiment of the present invention can be applied. It is to be noted that the television receiver explained below may be, e.g., a player apparatus to which a picture display apparatus (a monitor apparatus) is externally connected or a recorder apparatus (an information recorder/reproducer) that can record input pictures including moving picture data and audio data and output pictures and audio at the time of reproduction (playing).

A television receiver 11 explained in FIG. 1 includes: a television function part 101 including a satellite digital broadcast tuner module 44 that receives a satellite broadcast from a broadcast satellite or a communication satellite, a digital terrestrial tuner module 50 that receives a digital terrestrial broadcast, an analog terrestrial tuner module 52 that receives an analog terrestrial broadcast, an external input 59, an image processing unit 58 that processes picture data input from each tuner or the external input, a audio processing module 55 that processes audio data input from each tuner or the external input, a display 13 that displays a picture output from the image processing module 58, and a speaker device (an audio reproducing unit) 15 that reproduces audio output from the audio processing module 55; and a remote control part 103 including a network connection port (a communication interface (I/F) module) 73 that can transmit or receive information and data with respect to the outside, an advanced function processing module 80 that processes information input through the communication I/F module 73, and a graphic processing module 54 that displays a scheduler function or a messenger function processed by the advanced function processing module 80 in the display 13 in the television function part 101.

It is to be noted that the communication I/F module 73 includes local area network (LAN) connection that enables transmission and reception of information and data in accordance with a protocol typified by, e.g., Ethernet (a registered trademark). Further, in the television receiver 11, a wireless connection function based on a Bluetooth (a registered trademark) standard or an arbitrary number of connection interfaces which will be explained later are prepared in addition to the communication I/F module 73.

The communication I/F module 73 receives information provided from the outside via, e.g., the Internet by using a mobile terminal device 201 having a communicating function typified by, e.g., a mobile phone device, and inputs the received information to the advanced function processing module 80. The advanced function processing module 80 supplies a result of interpreting the input information to the image processing module 58 through the graphic processing module 54 in the television function part 101.

The mobile terminal device 201 has an application linked up with an application of this function mounted thereon, and is connected with an Ethernet input terminal (the communication I/F module 73) of the television receiver 11 via the Internet. That is, this device has a function of storing a moving picture message from a remote site into the television receiver 11. It is to be noted that the application mounted in the mobile terminal device 201 can be readily acquired by download from, e.g., a web site of a manufacturer who provides the television receiver 11 or a web site of a connection company to which the mobile terminal device 201 belongs (having a contractual relationship).

The advanced function processing module 80 is a control circuit that executes an application allowed in the entire television receiver 11 independently from the television function part 101 in the television receiver 11, and executes various kinds of processing, e.g., ON/OFF switching of a power supply of the television receiver 11, control over a reception (display) channel, acquisition of time information, decoding of schedule data, registration in a schedulers etc. in cooperation with each tuner in the television function part 101 and a clock part (a timer control module) 90.

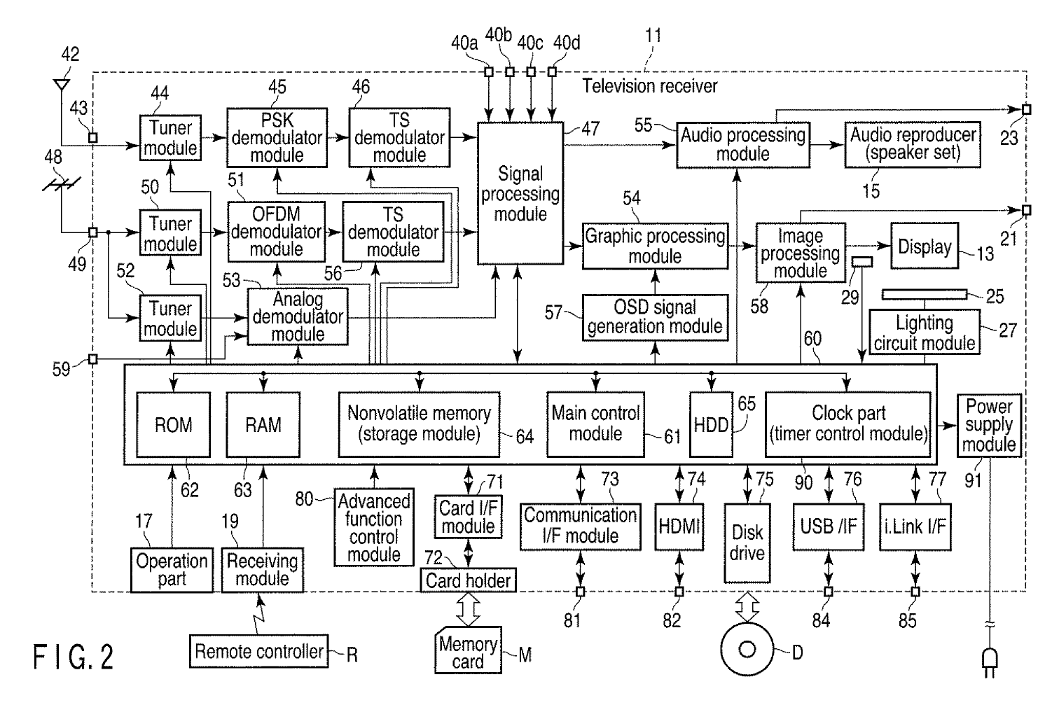

FIG. 2 is a schematic view for explaining the television function part 101 in the television receiver 11 depicted in FIG. 1.

The television function part 101 in the television receiver 11 includes a display 13 which is a display device typified by, e.g., a liquid crystal display panel and displays a picture associated with a picture signal (video data), a audio reproducer 15 which is a audio reproducer typified by, e.g., a speaker and reproduces a audio output (audio data), an operation part 17 which accepts a control instruction (control input) signal from a user, a remote control signal receiving module 19 which accepts an operation information (control input) signal from a remote controller R of the user, a control block (a control module) 60, etc. It is to be noted that the display 13 is, e.g., a liquid crystal panel device, which selectively transmits illumination light (backlight) from an attached illumination device 25 therethrough to display a picture. Furthermore, the illumination device 25 is turned on with a predetermined driving voltage that is specified based on the brightness of the circumference or a difference between a continuously lit time and an unlit time, ire., a temperature of the illumination device 25 by a lighting circuit module 27. It is to be noted that the brightness of the circumference (the vicinity) of the display 13 is sequentially changed based on a detection result obtained by a light quantity sensor 29 provided near the display 13.

The control module 60 includes a main control module (a main control large-scale IC (LSI)) 61 that is called a central processing unit (CPU) or a main processing unit (MPU).

The control module 60 (the main control module 61) controls the following respective parts (elements) in accordance with an operation input from the operation part 17, a remote control operation input sent from the remote controller R received by the receiving module 19 to receive operation information, or one of information and data supplied from the outside through the communication I/F module 73.

The control module 60 includes a read only memory (ROM) 62 that holds a control program executed by the main control module 61, a random access memory (RAM) 63 that provides a work area for the main control module 61, a storage module (a non-volatile memory (NVM)) 64 that holds, e.g., various kinds of setting information, control information, or information and data supplied from the outside through the communication I/F module 73 of the remote control part 103, and a hard disk drive (HDD, a mass-storage device) 65.

It is to be noted that the NVM 64 also holds a moving picture message that is fetched through the communication I/F module 73 of the remote control part 103 and supplied from the advanced function processing module 80 of the remote control part 103 via the control module 60 of the television function part 101, decoded schedule information, etc.

To the control module 60 is connected a group of an arbitrary number of interfaces, e.g., a card interface (I/F) module 71 that enables reading of information from a card-like medium (a memory card) M as a semiconductor memory and writing of information to the memory card M, a communication interface (I/F) module (network connection port) 73, a high-definition multimedia interface (HDMI) 74, a disk drive 75 that is used for reading information from an optical disk D, i.e., moving picture data or audio data and writing information into the optical disk, a USB interface (I/F), or an i. Link interface (I/F) 77, and the control module 60 functions as an external device adapted to each interface, a hub (an extension device), or a network control device.

The card I/F module 71 can read picture and audio files from the memory card M disposed in a card holder 72 and write picture and audio files in the memory card M.

The communication I/F module 73 is connected with a LAN terminal (a port) 81 to accept control information or moving picture data supplied via an external device, e.g., the mobile terminal device 201 or from the remote controller R. It is to be noted that the communication I/F module 73 can be connected with, e.g., a network attached storage (NAS) HDD, a personal computer (PC), or a DVD recorder having a built-in HDD when connected with a hub compatible with a LAN.

To the HDMI 74 is connected, e.g., a non-illustrated DVD recorder, an AV amplifier, or a hub through an HDMI terminal. It is to be noted that the AV amplifier is connected with, e.g., a DVD recorder or a DVD player. Furthermore, the hub can be connected with, e.g., an AV amplifier including an HDMI terminal, a PC, a DVD recorder having a built-in HDD, or a DVD player. It is to be noted that, when the HDMI terminal 82 is connected with a hub, it is possible to achieve connection with a network, e.g., the Internet, reading, reproduction, and writing (recording) of a moving picture file (picture data) or an audio file (audio data) between a PC, a mobile phone (201), and a mobile terminal on the network, and other devices.

The disk drive 75 reads information from the optical disk D based on, e.g., a DVD standard, i.e., moving picture data or audio data, or records such information. Moreover, when the set optical disk is based on a CD standard, audio data is read and reproduced, and a song title, a performance time, and other data are output to be displayed in the display 13.

The USB I/F 76 can be connected through a non-illustrated hub connected with a USB port 84 with, e.g., an HDD or a keyboard that is formed to be accessible via the USB I/F, and can supply or receive information to or from each USB device. Incidentally, it is needless to say that a card reader/writer for a mobile phone, a digital camera, or a memory card associated with the USB I/F 76 can be also connected.

Although not shown, the i. Link I/F 77 can be connected with, e.g., an external device such as an audio-visual (AV)-HDD or a digital video home system (D-VHS), an external tuner, or a set top box (STP (a cable television receiver)) in serial, and can transmit or receive information with respect to an arbitrary device connected thereto.

Incidentally, although not shown, it is needless to say that a network controller based on, e.g., a digital network alliance (DLNA (registered trademark)) or non-illustrated Bluetooth may be prepared in additional to each interface or in place of one or more interfaces, and a recorder device, an HDD device, or a portable terminal device that can transmit or receive data through such a controller or a standard may be connected.

The control module 60 includes a timer controller module (a clock part) 90. The clock part 90 manages a clock time or information, e.g., a reservation clock time (a date and hour) and a recording target channel for reserved recording that is set based on input from a user, and can hold this information. It is to be noted that the clock part 90 can constantly acquire “clock time information”, called a time offset table (TOT), in a digital broadcast that is received through the digital terrestrial tuner module 50. That is, the clock part 90 can perform clock time management equivalent to that of a device having a built-in wave clock. Further, it is needless to say that a time tone can be acquired at a predetermined time every day from a predetermined channel of an analog broadcast received by the analog terrestrial tuner module 52. Further, the clock part 90 also functions as a timer control module with respect to information for a scheduler function or a messenger function that is supplied from the mobile terminal device 201. Incidentally, it is needless to say that the clock part 90 can control ON/OFF (energization) of a power supply for a commercial power source by a power supply module 91 at a predetermined clock time that is specified by the scheduler function and the messenger function. That is, it is needless to say that a secondary power supply (e.g., DC (direct current) 31 V or 24 V, or 5 V) for the control module 60 and other modules, excluding elements having a relatively large power consumption such as the display 13, the signal processing module 47, or the HDD, is constantly assured in a state other than a situation where energization is physically difficult, e.g., a cord is out of a wall, and the display 13, the signal processing module 47, the HDD 65, and other modules are activated at a previously specified clock time.

A primary signal processing system in the television receiver 11 will now be explained.

A satellite digital television broadcast signal received through a BS/CS (satellite wave) digital broadcast receiving antenna 42 is supplied to the satellite digital broadcast tuner module 44 through an input terminal 43.

The tuner module 44 selects a broadcast signal of a desired channel based on a control signal from the control module 60, and outputs this selected broadcast signal to a phase shift keying (PSK) demodulator module 45.

The PSK demodulator module 45 demodulates the broadcast signal selected by the tuner module 44 based on the control signal from the control module 60 to obtain a transport stream (TS) including a desired program, and outputs the demodulated broadcast signal to a TS decoder module 46.

The TS decoder module 46 performs TS decoding processing with respect to a signal subjected to transport stream multiplexing based on a control signal from the control module 60, and outputs a digital picture signal and a digital audio signal of a desired program to the signal processing module 47. Further, the TS decoder module 46 outputs various kinds of data (service information) required to acquire a program (content) supplied based on digital broadcasting, electronic program guide (EPG) information, program attribute information (a program category or the like), subtitle information, and other information to the control module 60.

Moreover, a digital terrestrial broadcast signal received by a terrestrial broadcast receiving antenna 48 is supplied to the digital terrestrial broadcast tuner module 50 through an input terminal 49.

The tuner module 50 selects a broadcast signal of a desired channel based on the control signal from the control module 60, and outputs the selected broadcast signal to an orthogonal frequency division multiplexing (OFDM) demodulator module 51.

The OFDM demodulator module 51 demodulates the broadcast signal selected by the tuner module 50 based on the control signal from the control module 60 to obtain a transport stream including the desired program, and outputs this stream to a TS decoder module 56.

The TS decoder module 56 performs TS decoding processing with respect to a signal subjected to transport stream (TS) multiplexing under control of the control module 60, and outputs a digital picture signal and a digital audio signal of a desired program to the signal processing module 47. It is to be noted that the signal processing module 47 acquires various kinds of data required to acquire a program superimposed on a digital broadcast wave and supplied in this state, electronic program guide (EPG) information, program attribute information (a program category or the like), and other information, and outputs such information to the control module 60.

An analog terrestrial television broadcast signal received by the terrestrial broadcast receiving antenna 48 is supplied to the analog terrestrial broadcast tuner module 52 through the input terminal 49, thereby selecting a broadcast signal of a desired channel. The broadcast signal selected by the tuner module 52 is demodulated into analog content, i.e., an analog picture signal and an analog audio signal by an analog demodulator module 53, and then output to the signal processing module 47.

The signal processing module 47 selectively performs predetermined digital signal processing with respect to a digital picture signal and a digital audio signal respectively supplied from the PSK demodulator module 45 and the OFDM demodulator module 51, and outputs the processed signals to the graphic processing module 54 and the audio processing module 5D.

To the signal processing module 47 are also connected a plurality of (four in the illustrated example) input terminals 40a, 40b, 40c, and 40d. These input terminals 40a to 40d enable inputting analog picture signals and analog audio signals from the outside of the television receiver 11.

The signal processing module 47 selectively digitizes the analog picture signals and the analog audio signals respectively supplied from the analog demodulator module 53 and the input terminals 40a to 40d, carries out predetermined digital signal processing with respect to the digitized picture signals and audio signals, and then outputs the processed signals to the graphic processing module 54 and the audio processing module 55.

The graphic processing module 54 has a function of superimposing an OSD signal generated by an on-screen display (OSD) signal generation module 57 on a digital picture signal supplied from the signal processing module 47 and outputting an obtained signal. The graphic processing module 54 can selectively output an output picture signal from the signal processing module 47 and an output OSD signal from the OSD signal generation module 57, and can combine both the outputs so that each of the outputs constitutes a half of a screen and can output this combined output.

It is to be noted that the output OSD signal output from the OSD signal generation module 57 can be superimposed on the displayed moving picture in a “semitransparent” state (forming a part of a regular picture signal to be permeable) and output in this state when a parameter for a blending is set.

The graphic processing module 54 also performs processing of superimposing subtitle information on a picture signal based on a control signal from the control module 60 and the subtitle information when a broadcast signal has a subtitle signal attached thereto and a subtitle can be displayed. It is to be noted that the graphic processing module 54 supplies a moving picture message decoded in the advanced function processing module 80 or an image showing a scheduler function screen to the image processing module 58 in the television function part 101 through the control module 60 in the television function part 101.

A digital picture signal output from the graphic processing module 54 is supplied to the image processing module 58. The image processing module 58 converts the digital image signal fed from the graphic processing module 54 into an analog image signal in such a manner that this signal can be reproduced as an image (moving picture/still picture) output by the display 13, i.e., the display device (the monitor device). Incidentally, it is needless to say that an extended projection device (a projector device) or an external monitor device may be connected as an external device with an output terminal 12 connected with the image processing module 58. Further, a DVD recorder device using, e.g., an optical disk conforming to a DVD standard as a recording medium or a video recorder device using a conventional video tape as a recording medium may be connected with the output terminal 21.

The audio processing module 55 is connected to an audio reproducer 15, i.e., a speaker or the like, and converts a digital audio signal supplied from the signal processing module 47 into an analog audio signal. It is to be noted that, although not explained in detail, a audio signal (an audio output) may be of course output to an external speaker connected with an output terminal 23, an audio amplifier (a mixer amplifier), or a headphone output terminal prepared as one conformation of the output terminal 23 in such a manner that this audio signal can be reproduced as an audio output.

In the control module 60, information for the scheduler function or the messenger function input to the advanced function processing module 80 of the remote control part 103 from the mobile terminal device 201 through the communication I/F module 73 is checked for, e.g., double booking with respect to an already set recording reservation, clock time information provided by the clock part 90 and the NVM 64, a date and hour and a channel for a time order (a date order) in the scheduler function, and other factors. Further, the input information is classified as information for a specific person (a specified user) in the messenger function.

The remote controller R has an application linked up with an application of a main function installed in the television main body in addition to a regular television operating function, and has a function of storing, e.g., a moving picture message. It is to be noted that, although not explained in detail, the remote controller R has a camera (imaging) function, an image processing part that processes an acquired image, a microphone (audio input) function, an audio processing unit that processes input audio, and a character input function. Therefore, the remote controller R can transmit an image acquired by the remote controller R and audio data attached thereto to the television receiver 11. It is to be noted that the character input function does not have to enable input of characters through the main body alone, which differs from the mobile terminal device 201, having a function provided to a regular remote controller, e.g., a cursor moving function and determining function enabling input of specific characters from a character input screen displayed in the display 13 of the television receiver 11 can suffice.

The scheduler function and the messenger function based on the information input to the advanced function processing module 80 of the remote control part 103 will now be explained in detail.

For example, the mobile terminal device, i.e., the mobile phone device or the like 201 owned by a previously authorized user activates the television receiver 11. For example, an application held in the mobile phone device or the like 201 inputs a mail that can be decoded by the television receiver 11 to the advanced function processing module 80 of the remote control part 103 of the television receiver 11 through a LAN or a public telephone network. It is to be noted that the mail supplied from the mobile phone device or the like 201 to the television receiver 11 can specify the television receiver 11 as one receiver (an incoming call receiver) placed on (connected with) the network (a telephone line) and it does not have to be transmitted through, e.g., a server developed by a provider or a connection company. Therefore, the user can provide specific information (with respect to the television receiver 11) as if he/she makes a phone call to the television receiver 11.

The advanced function processing module 80 of the remote control part 103 in the television receiver 11 analyzes information supplied from the mobile terminal device 201, classifies the same based on, e.g., whether it is data utilized in the scheduler function, whether it is data utilized in the messenger function, or whether it is information concerning a regular recording reservation, and stores this information in the NVM 64 through the control module 60 of the television function part 101. It is to be noted that data supplied through the remote controller R is likewise analyzed and stored in the NVM 64 as required. Furthermore, the data from the remote controller R may be input through the receiving module 19 of the television function part 101 in some cases as explained above.

When the input information is, e.g., <schedule>, display of all of schedules with users family, display of a program reserved for viewing, display of a message, etc. are sequentially realized by operations of the clock part (the timer control module) 90, the NVM 64 and the main control module 61 based setup by user.

For example, in regard to <program reservation>, the NVM 64 stores “year/month/day”, “a clock time”, “a channel”, “a recording mode (a transfer rate)”, etc. Additionally, the timer control module (the clock part) 90 activates the display 13, the signal processing module 47, or the HDD 65 at a point in time where reaching a reservation time is detected or a predetermined time including a preset activation time, and a program (content) of a channel that should be recorded is recorded.

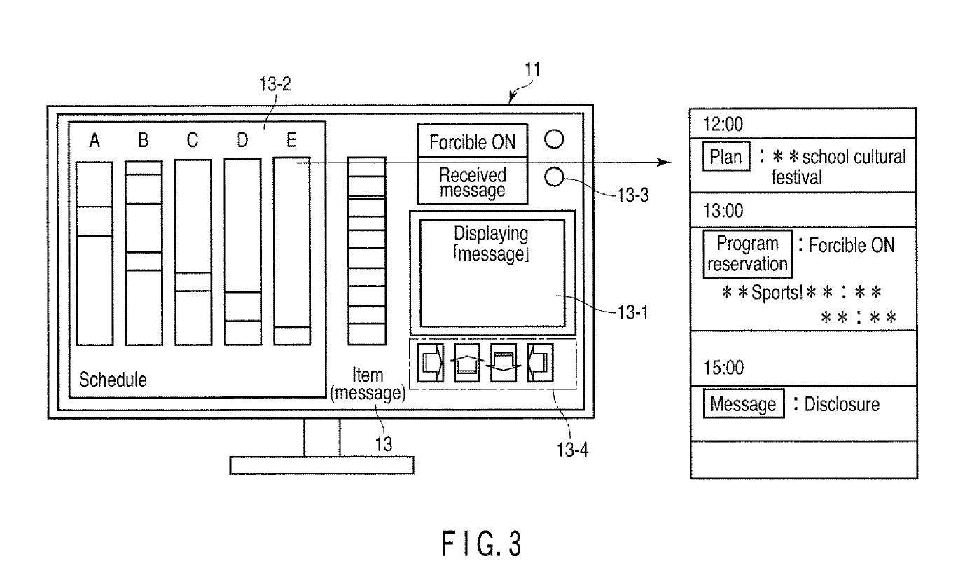

For example, in the case of <message>, “year/month/day” and “a clock time” held in the NVM 64, information of “disclosure” or “for a specific user”, and “a message (a character string)” are held. Further, in the case of <disclosure of message>, for example, such a message displaying area 13-1 as depicted in FIG. 3 is displayed in the display 13 through the graphic processing module 54. It is to be noted that, in a case where a type of a message is “for a specific user”, a message is displayed only when a user who is currently operating the television receiver 11 is specified as a designated “specific user” in accordance with <ID authentication> which will be explained later.

For example, in a case of <schedule>, “year/month/day” and “a clock time” held in the NVM 64, information of “disclosure” or “for a specific user”, and “a message (a character string or “an icon (a decorated letter)”)” are held. Furthermore, in <display of schedule>, such a schedule displaying area 13-2 as depicted in FIG. 3 is displayed in the display 13 through the graphic processing module 54. It is to be noted that, in a case where a type of a schedule is “for a specific user”, a message is displayed only when a user who is currently operating the television receiver 11 can be specified as a designated “specific user” in accordance with an authentication result of <ID authentication> which will be explained later.

Incidentally, in regard to the scheduler function and the messenger function, it is needless to say that an <auto ON mode (forced ON mode)> is supplementarily provided and the display is turned on automatically based on the program (the scheduler function and the messenger function), at least the display 13 is activated at a point in time where reaching a set clock time is detected or at a predetermined time including a preset activation time even if primary parts in the television receiver 11 are in an OFF mode (a standby mode), and “message display” or “schedule display” supplied from the graphic processing module 54 is displayed.

Moreover, in the schedule displaying area 13-2 associated with the scheduler function, a clock time (a date and hour) and “a schedule” are displayed together with a name or a photograph of a family (which can be previously acquired by a camera function of the mobile terminal device 201 or the remote controller R) or “an icon” typified by, e.g., “dad (father)” or “mom (mother)” held in the television receiver 11 are displayed in respective displaying areas denoted by, e.g., A, B, C, D, and E based on preset personal (family) information.

Additionally, as the messenger function, notification is performed as lighting or blinking “an indicator” 13-3 indicative of presence/absence of a message or display of a predetermined color based on set information of “disclosure” or “a specific user” supplementarily provided to <message> in advance. Of course, in the case of <message> involving clock time information, the display 13 may be turned on based on the above-explained <auto ON mode>.

It is to be noted that, in the messenger function, input (received) messages are classified into “disclosure” or “a specific user (nondisclosure)” by analysis of the advanced function processing module 80 and messages classified to “disclosure” are sequentially displayed. Further, each message classified to “nondisclosure (a specific user)” is annunciated by display of “You have a message” by the “indicator” 13-3 when a specific user checked in later-explained <ID authentication> operates the television receiver 11.

Furthermore, the television receiver 11 can select a <auto OFF mode (forced OFF mode)> together with the <auto ON mode>. For example, when a user who is currently operating the television receiver 11 is a child as a result of <ID authentication>, the <auto OFF mode> is useful for a request of a user, e.g., a request for a limitation of viewing middle of the night programs (contents).

It is to be noted that display of a function switch display group 13-4 depicted in FIG. 3 is highlighted based on an input instruction (an operation) from the remote controller R and it is used for, e.g., skip selection of <message> or display (scroll) of a schedule that is not displayed in a displaying area. A specific function, e.g., ‘move “message” to “schedule”’ that is used to move a recorded or received “message” to a “schedule” is given to display of one of the displayed function switches (switch display group) 13-4 as will be explained later. Furthermore, another one in display of the function switches another one of the displayed function switches (switch display group) 13-4 is used to record a “memo” with respect to a clock time selected (set) in the schedule displaying area 13-2 or a clock time immediately before the former clock time.

It is to be noted that each display, e.g., the message displaying area 13-1 or the schedule displaying area 13-2 can be displayed in the entire screen by using, e.g., a scaler function in the graphic processing module 54 based on settings or an operation of, e.g., a non-illustrated “full screen” button of the remote controller R.

A method of inputting a message to the advanced function processing module 80 in the remote control part 103 (a message function) will now be explained in detail.

For example, a message which has a moving picture or a still picture and audio recorded therein and is transmitted from a sender (a transmitter) using the camera-equipped mobile phone 201 or a camera installed in the remote controller R is received in a mail format (a main text with an attached file) by the advanced function processing module 80 in the television receiver 11.

The mail received by the television receiver 11 is processed (analyzed) by the advanced function processing module 80, and then stored in a part of a memory (not shown) that is firmware in the NVM 64, the HDD 65, or the control module 60 as a message. It is to be noted that “setting information (an ID, disclosure/nondisclosure, a clock time, a specific person)” is written in the mail text, and the attached moving picture data is treated as a reproduced message.

In more detail, for example, when recording a message (a schedule) in the television receiver 11 by using the mobile phone (the mobile terminal device) 201, the mobile phone that has downloaded an application compatible with this function in advance is used to activate a message recording function, and a camera and a microphone provided in the mobile phone are utilized to record the message.

Subsequently, a completion button (a setting button) or the like is used to terminate recording the message, “a display clock time”, “a specified person (a user name)”, “disclosure/nondisclosure”, etc. are set in accordance with the prepared application, and the mail is transmitted to a preset transfer destination.

The mail, i.e., the mail text and the attached data as a transfer target is transferred in “a mail” with attached file format to the communication I/F module 73 of the television receiver 11 through the Internet or a public telecommunication network.

The mail received by the television receiver 11 is processed (analyzed) by the advanced function processing module 80 in accordance with the set information written in the mail, and it is stored at a corresponding storage position.

On the other hand, in regard to transfer of the message by the remote controller R, for example, when a <message> button in the remote controller R is operated, the camera provided in the remote controller R is activated, and a user who is performing operation (self-portrait image) or an imaging target intended by the user, is imaged. This acquired image is displayed in a predetermined display screen activated in accordance with the previously activated application of this function in the display 13 when the display 13 in the television receiver 11 is in the ON state. Of course, when a picture (an image) is not attached, imaging of the picture (the image) is not required (the processing can advance to subsequent “recording”).

Then, although not shown, pressing (turning on), e.g., a “recording” button enables recording a message for up to approximately 30 seconds. Subsequently, although not shown, pressing (turning on), e.g., a “setting” button enables setting “a display clock time”, “a specific person (a user name)”, “disclosure/nondisclosure”, etc. in accordance with the prepared application. Although not shown, when, e.g., a “transfer” button is pressed (turned on), a message (a control instruction mail from the remote controller R) is stored (input) in the television receiver 11 via the advanced function processing module 80 by using the receiving module 19 (or the communication I/F module 73) in the television receiver 11.

It is to be noted that, when specifying a person who has made an input (who has configured a setting), registering a face of a specific person that has been previously imaged by the attached camera in the television receiver 11 and specifying this face by a mail enables displaying the person who has made an input (who has configured a setting) when displaying a schedule or displaying a message.

A message confirming method performed by the television receiver 11 will now be explained in detail.

For example, when the power supply of the television receiver 11 is turned on based on an operation of the remote controller R by a user, display information at the time of turning on the power supply that is output to the display 13 from the image processing module 58, e.g., a monochromatic image of blue with respect the full screen, a supply source of a currently selected program (content) typified by, e.g., <a terrestrial digital broadcast>, an output mode of the audio output typified by, e.g., <bilingual>, etc. are displayed. That is, an initialization state when the television receiver 11 is activated is annunciated.

In the communication I/F module 73, a recording reservation or presence/absence of received data, e.g., a schedule (input) or a message (input) is checked (automatically received) at the same time or a predetermined timing.

Subsequently or at a predetermined timing, <ID authentication> that is utilized for disclosure of a schedule or a message for a specific user, an arbitrary function, or a limitation of viewing is carried out.

For example, when a preset simple password (authentication information including, e.g., a number string of several digits or a name of a favorite animal) is input by operating the remote controller R or directly input from the operation part 17 in the television receiver 11 to recognize an operator, <ID authentication> is carried out.

When the <ID authentication> checks that the current operator can operate the television receiver 11 or view a program (content), such a schedule displaying area and a message displaying area as exemplified in FIG. 3 are displayed in the display 13.

For example, at the time of inputting a schedule, the schedule can be input in a display area prepared for an operator (a user) authenticated based on the <ID authentication>.

Further, in regard to a “disclosure” schedule, the number of schedules that can be displayed in a displaying area are displayed in the displaying area 13-2 or they are displayed in the displaying area 13-2 in units of a predetermined time when the <ID authentication> is terminated.

On the other hand, when a message is received or when a message is held in the messenger function by direct input, presence of the message is informed based on, e.g., lighting of the “indicator” 13-3, display of a predetermined color, or blinking. It is to be noted that, in regard to a message prepared for an operator from a specific person, the “indicator” 13-3 informs presence of the message only when the message for the operator (a user) authenticated based on the <ID authentication> is present.

When displaying (opening) messages is instructed (input) by an operation of the remote controller R or by direct input from the operation part 17, the number of messages that can be displayed in the displaying area are displayed in the displaying area 13-1 or they are displayed in the displaying area 13-1 in units of a predetermined time. It is to be noted that the number of messages classified into “disclosure” that can be displayed in the displaying area may be automatically displayed in the displaying area 13-1 or may be automatically displayed in the displaying area 13-1 in units of a predetermined time when the <ID authentication> is terminated.

Moreover, when a password for a manager is input, schedules for all members can be input

Additionally, a message or a schedule addressed to (for) a specific person, addressed to (for) a user, or addressed to (for) all members can be input (recorded) from the outside (a destination of a trip or a remote site) by using a mail from the mobile terminal device 201. It is to be noted that when a recorded or received “message is moved to a “schedule”, the message (a moving picture message) can be set in the schedule.

For example, when a non-illustrated arrow key in the remote controller R is used to select one of the function switches in the function switch display group 13-4 displayed in the display 13 and, e.g., a non-illustrated “determination” key is activated, the recorded or received “message” is moved to the “schedule” in accordance with a function previously assigned to the function switch display group 13-4, e.g., ‘move “message” to “schedule”’.

Additionally, when, e.g., a “memo” previously assigned to the arrow key in the remote controller R and one of the function switches in the function switch display group 13-4 is selected and “a clock time” is set (selected based on, e.g., scroll) in the schedule displaying area 13-2, the “memo” can be recorded with respect to a clock time selected in the schedule displaying area 13-2 or a clock time immediately before this selected time.

For example, in regard to a viewing reservation, when a program which should be reserved is highlighted by the remote controller R and the “determination” key or the like is turned on in a state where a timetable (a program table format) is displayed in the display 13, a corresponding program enters a viewing reservation state. When the start time arrives, the primary units in the television receiver 11 are activated by an operation of the power supply module 91 under control of the timer control module 90, thereby displaying a program of a reserved channel.

It is to be noted that viewing reservations are redundantly set for the same clock time, and “overlap” is displayed, for example. In this case, as will be explained later, when the number of programs redundantly reserved for viewing is within a predetermined number, a “multiscreen display function” is executed. Further, although the “multiscreen display function” is enabled, a message, e.g., “Do you wish use a multiscreen display?” is displayed in the display 13 at a clock time that viewing reservations are set. As a result, an operator (a user) can select recording any one of the program, canceling the viewing reservations, or using the “multiscreen display”. It is to be noted that a viewing method can be preset in a setting screen (priority can be given to the “multiscreen display”; of course, the “overlap”, i.e., the “multiscreen display” can be prevented from being allowed).

A scheduler function (automatic display of a schedule) of the television receiver 11 will now be explained in detail.

As explained above, the schedule displaying area 13-2 provided by the scheduler function can be displayed in the display 13 of the television receiver 11.

For example, a timetable (program table format) display screen (channel) based on the schedule display function is prepared for a vacant channel, and the following display can be performed at each clock time as needed, for example:

displaying (confirming) a family schedule on a daily basis;

displaying a viewing (recording) reservation of a program (content); and

automatically displaying a message (urging follow-up or a periodic activity for a specific person).

In more detail, in a setting where one channel that is not occupied by a broadcast is assured as a scheduler screen (a display channel) and a channel occupied by a broadcast is skipped by using, e.g., an up-and-down (scroll) key in the remote controller R, when the scheduler screen is also displayed by using a channel close to a counterpart that is usually utilized for viewing as if the scheduler screen is associated with one channel, anyone can confirm (visually recognize) the “scheduler function”, i.e., schedule display without a feeling of strangeness.

It is to be noted that using, e.g., a screen dividing function or a sub-screen display function enables simultaneously displaying a schedule at the time of viewing a regular television broadcast program or reproducing (viewing) arbitrary content. Further, a predetermined percentage alone of a currently displayed screen (picture) can be subjected to permeation to display the message displaying area or the schedule displaying area by using the “α blending” function provided by the OSD signal generation module 57.

Furthermore, a message automatic display function can be used to manage a schedule of each member in a family. For example, the management includes “following up learning” or “informing a time to go to, e.g., an after school/a private school (urging go-off)” for a child or informing an aged person of “a time to take a tablet (take a medicine)”. It is to be noted that “following up a bedtime hour” or the like may be carried out with respect to a child.

As an actual utilization method, when a preset simple password (e.g., a number string of several digits or a name of a favorite animal) is input from, e.g., the remote controller R or the operation part 17 of the television receiver 11 to recognize a current operator, a scheduler can be input in a display area of the operator (a user) (if the schedule is disclosed, anyone can confirm it). It is to be noted that, when a password for a manager is input, schedules of all members can be input as explained above. Moreover, a message or a schedule addressed to (for) a specific person, addressed to (for) a user himself/herself, or addressed to (for) all members can be input (recorded) from the outside (a destination of a trip or a remote site).

A message that should be linked up with a “schedule”, e.g., a recording (viewing) reservation in “messages” received by the television receiver 11 or input through the remote controller R is analyzed by the advanced function processing module 80, and held as a schedule in the NVM 64. It is to be noted that, when an operator confirms display of the display 13 of the television receiver 11 and the non-illustrated arrow key in the remote controller R and the function switch display group 13-4 displayed in the display 13 are used to move the “message” displayed in the message displaying area 13-1 to the schedule displaying area 13-2, a “schedule” associated with the received message can be easily set.

Moreover, as already explained above, when the “memo” as one switch in the function switch display group 13-4 is selected, the “memo” can be recorded as a clock time selected (set) in the schedule displaying area 13-2 or a clock time immediately before this time.

An ID authentication function at the time of reproduction (at the time of activation) by the television receiver 11 will now be explained in detail.

As already explained above, when a preset simple password (e.g., a number sequence of several digits or a name of a favorite animal) is input by operating the remote controller R or directly input from the operation part 17 in the television receiver 11 to carry out the <ID authentication> with respect to an operator, a fixed limitation can be put on viewing of a program (content) or use of the television receiver 11 under specific conditions or for a specific operator. Further, in regard to a specific program or content, the television receiver 11 can be forcibly turned on under control of the timer control module 90 to urge an operator to view the program or content.

For example, when a current operator is authenticated as a child based on the <ID authentication>, a limitation can be put so that television programs or content cannot be viewed in a late-night or specific time zone. Furthermore, the television receiver 11 can be subjected to <auto ON mode> at a specified time to display an educational program.

It is to be noted that, when the power supply of the television receiver 11 is turned off after termination of viewing based on the <ID authentication>, a limitation on viewing with respect to an authenticated ID (an operator) or the display is turned on automatically based on the program (reproduction of content) is canceled. Further, a limitation on viewing using the <ID authentication> or the display is turned on automatically based on the program (reproduction of content) is locked when the power supply is turned on the next time. Therefore, for example, a limitation on viewing with respect to a child is continuously maintained even if the power supply of the television receiver 11 is temporarily turned off (in practice, since a password is required for the <ID authentication> when the power supply is turned on the next time, a limitation on viewing is continued at a point in time where an operator is specified based on the ID authentication, for example).

A picture display method (a multiscreen display function) of the television receiver 11 using the scheduler function will now be explained in detail.

The above has explained the example where, e.g., “overlap” is displayed and “multiscreen display” is executed when viewing reservations are redundantly set for the same hour. In more detail, when a plurality of family members set viewing reservations of different programs which are on air at the same clock time by using the scheduler function, “overlap” is displayed at the time of making reservations. However, when viewing is desired (all schedules are not canceled or not changed to recording), programs (content) of a plurality of channels can be displayed based on “multiscreen display” up to a maximum number of built-in tuners.

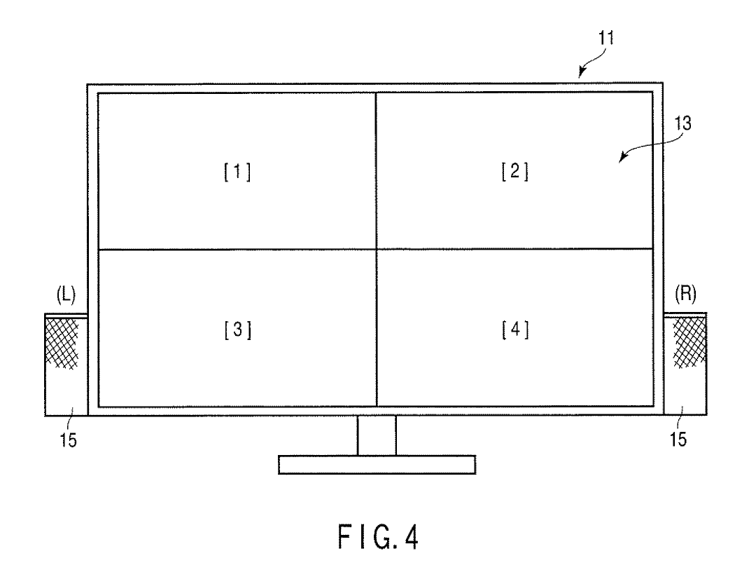

It is to be noted that, in the “multiscreen display”, when, e.g., four programs (content) are viewed (displayed) as shown in FIG. 4, up to arbitrary two channels can be selected in regard to audio. In this case, when the audio reproducers 15, i.e., the speaker devices connected with the audio processing module 55 are compatible with a stereo system (two channels), independently using the respective right and left speaker devices enables simultaneously reproducing audio of two channels (programs) which correspond to a combination of monaural audio and monaural audio, though. It is to be noted that output of such independent audio can be realized by a parallel processing capability of the advanced processing module 80. In regard to audio to be reproduced, audio that can be reproduced on such a left-hand side “L” as shown in FIG. 4 is audio in one of programs [1], i.e., left side upper program and [3], i.e., left side lower program, and audio that can be reproduced on a right-hand side is audio in one of programs [2], i.e., right side upper program and [4], I.e., right side lower program, and audio can be arbitrarily selected. It is to be noted that, although not explained in detail, audio can be readily selected by using the arrow key in the remote controller R and a predetermined one of the function switches in the function switch display group 13-4 displayed in the display 13, e.g., a “audio selection (function)”.

A picture display method (a setting automatic changing function) of the television receiver 11 using the scheduler function will now be explained in detail.

According to the scheduler function explained above, a clock time is constantly monitored. Therefore, a maximum value of output audio can be changed in, e.g., a late-night zone. Further, for example, in a viewing environment where illumination is somewhat dimmed at night, there is known a factor that eyes do not get tired when the brightness of the display 13 (an intensity of illumination light in a liquid crystal panel device, or a luminance in a known CRT) is suppressed, for example.

Based on such a background, when a current time zone is obviously a late-night zone, reducing a audio output by using the timer control module 90 and the scheduler function enables viewing a program (content) at a preferable audio level which is not considered to be noisy with respect to, e.g., houses in the neighborhood. Further, both suppressing illumination light or a luminance and reducing an audio output are useful for electric power saving. Incidentally, in regard to brightness of the display 13, utilizing a result of detecting the ambient brightness obtained by the light quantity sensor 29 depicted in FIG. 2 enables displaying (reproducing) a more preferable picture.

As explained above, according to one embodiment of the present invention, the television receiver alone can make a viewing reservation or utilize the scheduler function and the messenger function without using dedicated input equipment (a video camera or a personal computer (PC)). Furthermore, a viewing reservation, especially, a reservation from, e.g., a remote site can be easily made by using the television receiver alone.

Further, communication between family members can be further improved through the television receiver.

Furthermore, a message displayed by the television receiver can be transmitted by the moving picture message function in the form of audio and a moving picture provided by a transmitter or an operator which are different from text (a character string). That is, when a moving picture is used as a message, expressions or feelings of an input person (a transmitter) or an object (an imaging object) can be imaged and transmitted to the other party.

Moreover, since an input schedule or moving picture message is automatically reproduced at a planned clock time, a specific operator can be informed of, e.g., “a time to take a tablet (take a medicine)”.

Additionally, viewing of a program (content) can be restricted for a specific operator by using the <ID authentication> function.

Further, when a plurality of viewing reservations are redundantly made, the number of programs (content) equal to the number of the tuners can be independently displayed (reproduced) by using the multiscreen display function.

Furthermore, programs (content) displayed (reproduced) in the multiscreen display function can be independently reproduced in two systems (two channels) which correspond to a combination of monaural audio and monaural audio, though.

Moreover, in, e.g., a latenight zone, a audio output can be appropriately reduced based on management of the scheduler.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A video and audio reproduction apparatus comprising:
a display configured to display an image;
a communication control module configured to receive instruction information including moving picture or still picture data and audio data;
a receiving module (tuner/external input part in FIG. 1) configured to receive a program or content;
an information processing module configured to analyze the instruction information received by the communication control module;
a data holding module configured to hold at least one of acquisition reservation information of a program or content as an acquisition reservation target in the receiving module, a message included in an analysis result obtained by the information processing module, and setting information included in the analysis result obtained by the information processing module in accordance with the analysis result obtained by the information processing module;
a display processing module configured to display in the display a screen associated with at least one of the acquisition reservation information, the message, and configured to set information held by the data holding module;
a clock module configured to manage clock time information; and
a control module configured to control at least one of the receiving module and the display in accordance with at least one of the acquisition reservation information, the message, and the setting information displayed in the display by the display processing module based on the clock time information from the clock module.

2. The video and audio reproduction apparatus of claim 1, wherein the instruction information received by the communication control module includes a mail format having moving picture or still picture data and audio data attached thereto.

3. The video and audio reproduction apparatus of claim 1, wherein the clock module controls connection and disconnection of a commercial power supply that is used to activate at least the display.

4. The video and audio reproduction apparatus of claim 1, wherein the information processing module analyzes the instruction information received by the communication control module and provides a scheduler function.

5. The video and audio reproduction apparatus of claim 1, wherein the information processing module puts a constant limitation based on authentication information input through the communication control module.

6. The video and audio reproduction apparatus of claim 1, wherein when activation of the display based on the acquisition reservation information received through the communication control module and acquisition of a program or content by the receiving module are carried out at the same clock time, the information processing unit divides a screen output from the display processing module to the display in accordance with the number of pieces of the acquisition reservation information set for the same clock time and displays the program or the content corresponding to each piece of acquisition reservation information in the display.

7. The video and audio reproduction apparatus of claim 4, wherein the information processing module reduces a level of an audio output in a specific time zone based on a result of analyzing the instruction information received by the communication control module.

8. The video and audio reproduction apparatus of claim 1, wherein the information processing module analyzes the instruction information received by the communication control module and provides a messenger function.

9. A video and audio reproduction apparatus comprising:
a television function part; and
a remote control part,
the television function part including:
a picture processing module configured to reproduce picture data;
a display configured to display an output from the picture processing module;
a audio processing module configured to reproduce audio data;
a audio reproducer configured to reproduce an output from the audio processing module;
a graphic processing module configured to output at least one of a graphic and character information to the picture processing module to be reproducible;
a clock module configured to manage a clock time;
a power supply configured to connect a commercial power supply to at least the picture processing module, the display, the audio processing module, the audio reproducer, and the graphic processing module; and
a data holding module configured to hold setting information and control information,
the remote control part including:
a communication control module configured to receive control information and configured to set information supplied through a network or a communication line; and
an information processing module configured to analyze the control information and the setting information acquired by the communication control module and configured to sort and store a result of analysis as data for a messenger function, data for a scheduler function, authentication information, or the setting information,
wherein a message displaying area configured to be used as the messenger function and a schedule displaying area configured to be used as the scheduler function are displayed in the display in the television function part based on the control information and the setting information analyzed by the information processing unit in the remote control part in accordance with a clock time managed by the clock module when a commercial power is connected with the picture processing module, the display, the audio processing module, the audio reproducer, and the graphic processing module through the power supply.

10. The video and audio reproduction apparatus of claim 9, wherein the instruction information received by the communication control module includes a mail format having moving picture or still picture data and audio data attached thereto.

11. The video and audio reproduction apparatus of claim 10, wherein the instruction information received by the communication control module has a main format having moving picture or still picture data and audio data attached thereto based on an application that is available when downloaded in a mobile phone device.
